(19) United States
(12) Patent Application Publication
(10) Pub. No.: US 2009/0290327 A1
(43) Pub. Date: Nov. 26, 2009

(54) BACKLIGHT ASSEMBLY AND DISPLAY DEVICE HAVING THE SAME

(76) Inventors: Heung-Seok KIM, Yongin-si (KR); Wee-Joon Jeong, Seoul (KR)

Correspondence Address: F. CHAU & ASSOCIATES, LLC, 130 WOODBURY ROAD, WOODBURY, NY, 11797, US

(21) Appl. No.: 12/464,936

(22) Filed: May 13, 2009

(30) Foreign Application Priority Data
May 21, 2008 (KR) 10-2008-0047220

(51) Int. Cl. G02F 1/13357

(52) U.S. Cl. 362/97.1

(57) ABSTRACT

A backlight assembly includes a receiving member comprising a bottom plate, a first sidewall portion substantially perpendicularly connected to a first end of the bottom plate, and a second sidewall portion substantially perpendicularly connected to a second end of the bottom plate, the first sidewall portion and the second sidewall portion facing each other, wherein a plurality of through grooves are formed in the first sidewall portion and the second sidewall portion, and a plurality of light source units, each light source unit comprising a light-emitting region and an end region, the light-emitting region disposed between the first end and the second end of the bottom plate, the end region penetrating each of the through grooves, wherein each of the light source units is coupled to the receiving member.

This application claims priority from Korean Patent Application No. 10-2008-0047220 filed on May 21, 2008, the disclosure of which is incorporated herein by reference in its entirety.

### BACKGROUND OF THE INVENTION

1. Technical Field

The present disclosure relates to a backlight assembly and a display device having the same, and more particularly, to a backlight assembly having an improved coupling structure between light sources and a receiving member.

2. Discussion of the Related Art

Liquid crystal displays (LCDs) are flat panel displays (FPDs). To display an image, an LCD controls light transmittance by changing the arrangement of liquid crystals in each unit pixel. Since the LCD is not a self light-emitting display, the LCD includes a backlight assembly which is disposed under a liquid crystal display panel and provides light to the liquid crystal display panel.

A conventional backlight assembly includes a light source, various elements which are used to provide light emitted from the light source to a liquid crystal display panel, and a receiving member which accommodates the above elements. The conventional backlight assembly further includes a mold frame, which is coupled to opposite ends of a receiving member. The mold frame fixes the light source to the receiving member and supports various optical elements (e.g., an optical sheet or an optical plate) disposed on the light source.

However, the mold frame is coupled to the receiving member in a separate assembly process. Furthermore, the mold frame is manufactured by a separate injection process and then added to the backlight assembly. As such, the manufacturing efficiency decreases when the mold frame is formed in the backlight assembly.

In addition, the end region of the light source, which is fixed to the receiving member by the mold frame, may be seen as a dark portion.

### SUMMARY OF THE INVENTION

According to an exemplary embodiment of the present invention, a backlight assembly does not require a mold frame. As such, dark portions of light sources can be reduced, and manufacturing efficiency can be increased.

According to an exemplary embodiment of the present invention, a backlight assembly comprises a receiving member comprising a bottom plate, a first sidewall portion substantially perpendicularly connected to a first end of the bottom plate, and a second sidewall portion substantially perpendicularly connected to a second end of the bottom plate, the first sidewall portion and the second sidewall portion facing each other, wherein a plurality of through grooves are formed in the first sidewall portion and the second sidewall portion, and a plurality of light source units, each light source unit comprising a light-emitting region and an end region, the light-emitting region disposed between the first end and the second end of the bottom plate, the end region penetrating each of the through grooves, wherein each of the light source units is coupled to the receiving member.

A part of the end region of each light source unit may protrude beyond the bottom plate through each through groove.

Each of the first and second sidewall portions can comprise an inner sidewall extending upward from an end of the bottom plate, a connecting surface extending from an upper end of the inner sidewall, and an outer sidewall extending downward toward the bottom plate from an end of the connecting surface.

Each of the through grooves can comprise a first groove portion formed in the inner sidewall and a second groove portion formed in the outer sidewall.

The first and second groove portions can have different sizes.

Each of the first and second sidewall portions can further comprise a plurality of protrusions protruding upward from the connecting surface.

The backlight assembly may further comprise an optical member placed on the receiving member, the optical member having a plurality of slits for receiving the protrusions therein.

The protrusions can be formed by cutting portions of the connecting surface and bending the cut portions upward.

The bottom plate can be shaped like a square.

The receiving member may further include a third sidewall portion and a fourth sidewall portion facing each other formed on the bottom plate.

The through grooves can be formed in at least one of the first through fourth sidewall portions.

The first sidewall portion and the second sidewall portion can have the same number of the through grooves.

Each of the light source units may further comprise a light source body emitting light, electrode portions formed at both ends of the light source body, and a light source holder receiving the electrode portions therein, wherein the light source holder is inserted into each of the through grooves.

The light source holder can penetrate each of the through grooves such that an end of the light source holder can be exposed outside the receiving member.

A substantial portion of the light source holder can be placed between the inner sidewall and the outer sidewall.

The light source holder may further comprise fixing groove portions receiving a part of one of the first and second sidewall portions.

Each of the light source units may further comprise voltage supply wires penetrating the light source holder and can be connected to the electrode portions.

The light source holder may further comprise wire fixing grooves for extending the voltage supply wires out of the light source holder.

The wire fixing grooves can penetrate both of rear and bottom surfaces of the light source holder, and the voltage supply wires extend out of the light source holder through the rear surface of the light source holder and bent toward the bottom surface of the light source holder.

The wire fixing grooves can comprise first wire outlets formed in the rear surface of the light source holder and second wire outlets formed in the bottom surface of the light source holder, wherein the first wire outlets and the second wire outlets are not aligned along a straight line.

A cross-section of each of the wire fixing grooves can be shaped like “ [symbol] ”.

The bottom plate may include a first portion and a second portion coupled to the first portion.

Each of the third wall portion and the fourth wall portions can be divided into two regions.

The first portion and the second portion of the bottom plate can be combined using protruded and recessed patterns.

The through grooves can be formed in at least one of the first and second sidewall portions.

The backlight assembly may further comprise a reflective sheet attached to the bottom plate and a surface of each of the first and second sidewall portions.

According to an exemplary embodiment of the present invention, a display device comprises a backlight assembly comprising a receiving member, the receiving member comprising a bottom plate and sidewall portions forming a space, wherein a plurality of through grooves are formed in each of two sidewall portions facing each other; and a plurality of light source units, each light source unit comprising a light-emitting region disposed in the space and an end region penetrating each of the through grooves, and a display panel disposed on the receiving member, wherein each of the light source units is coupled to the receiving member.

A part of the end region can protrude from the space in a direction away from a center of the space.

The display device may further comprise a panel support member interposed between the receiving member and the display panel, the panel support member fixing and supporting the display panel, and an optical member interposed between the panel support member and the light source units.

Each of the two facing sidewall portions may comprise an inner sidewall extending upward from an edge region of the bottom plate, a connecting surface extending from an upper end of the inner sidewall in the direction away from the center of the space, and an outer sidewall extending downward toward the bottom plate from an end of the connecting surface.

Each of the through grooves may comprise a first groove portion formed in the inner sidewall and a second groove portion formed in the outer sidewall.

Each of the two facing sidewall portions may further comprise a plurality of protrusions protruding upward from the connecting surface.

The optical member may further comprise a plurality of slits for receiving the protrusions, and the panel support member further comprises grooves for receiving the protrusions.

### BRIEF DESCRIPTION OF THE DRAWINGS

Exemplary embodiments of the present invention can be understood in more detail from the following description taken in conjunction with the accompanying drawings, in which:

FIG. 1 is an exploded perspective view of a display device according to an exemplary embodiment of the present invention;

FIG. 2 is a cross-sectional view of a display device according to an exemplary embodiment of the present invention;

FIG. 3 is a perspective view of a light source holder according to an exemplary embodiment of the present invention;

FIG. 4 is a perspective view of a lower receiving member according to an exemplary embodiment of the present invention;

FIG. 5 is a perspective view of a lower receiving member which is coupled to a plurality of light source units according to an exemplary embodiment of the present invention;

FIG. 6 is a cross-sectional view of a display device according to an exemplary embodiment of the present invention;

FIG. 7 is a rear perspective view of a lower receiving member which is coupled to a plurality of light source units according to an exemplary embodiment of the present invention;

FIGS. 8 and 9 are cross-sectional views of a backlight assembly according to an exemplary embodiment of the present invention;

FIG. 10 is an exploded perspective view of a display device according to an exemplary embodiment of the present invention; and

FIG. 11 is a cross-sectional view of a display device according to an exemplary embodiment of the present invention.

### DETAILED DESCRIPTION OF THE INVENTION

The invention is described more fully hereinafter with reference to the accompanying drawings, in which exemplary embodiments of the invention are shown. The present invention may, however, be embodied in many different forms and should not be construed as being limited to the embodiments set forth herein.

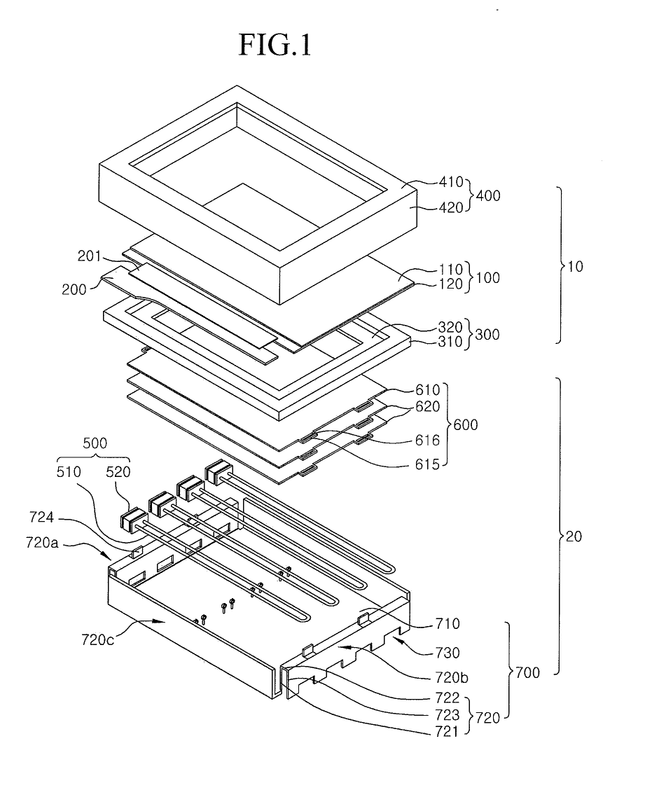

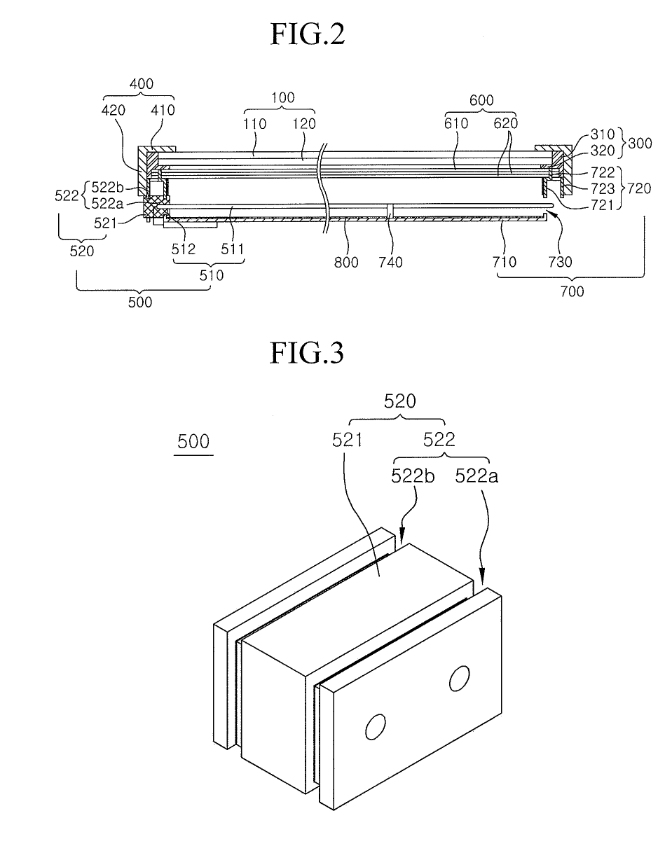

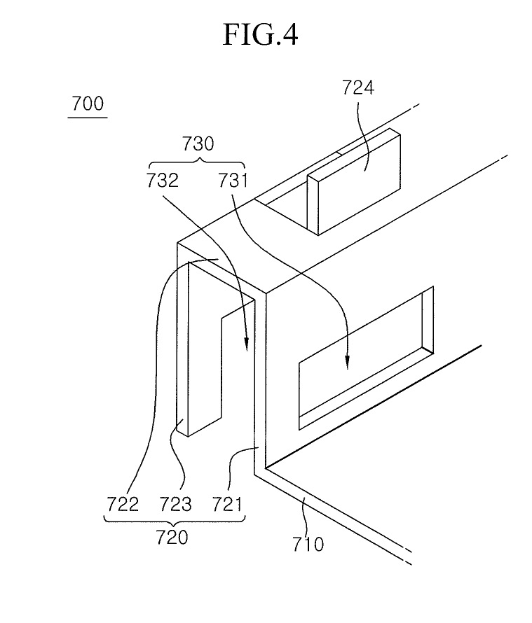

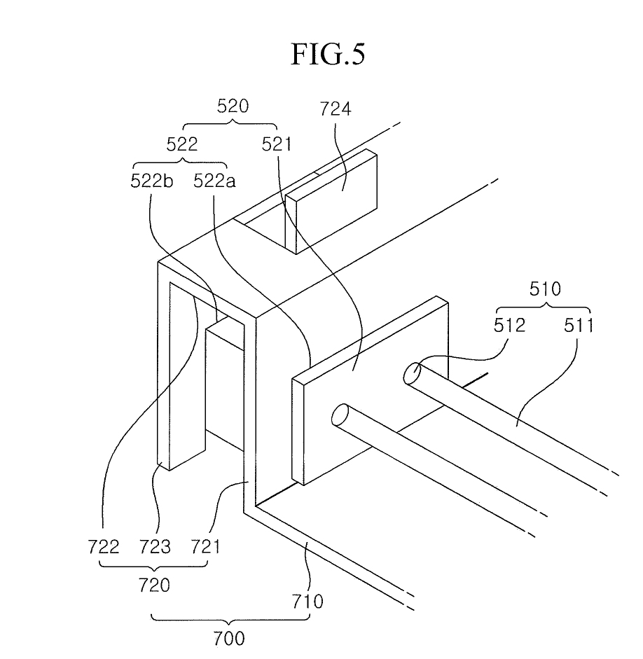

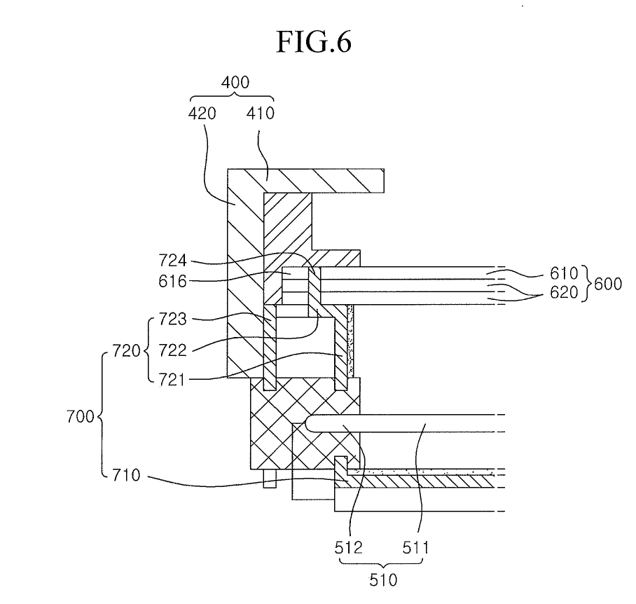

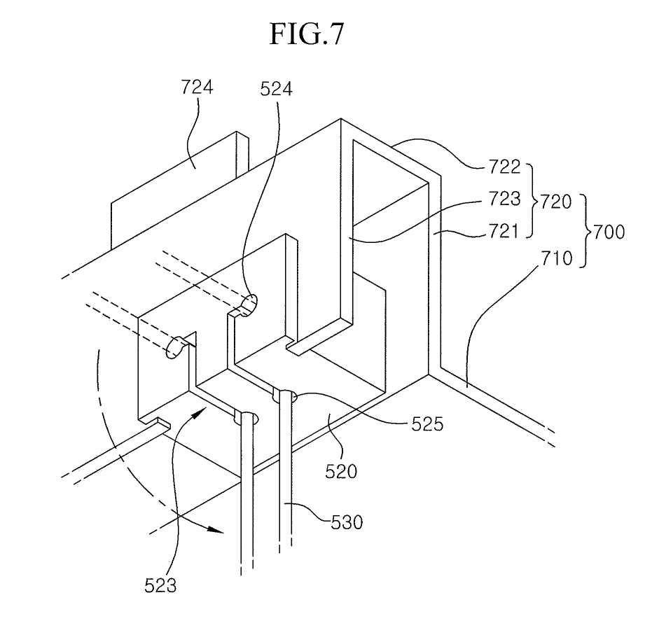

FIG. 1 is an exploded perspective view of a display device according to an exemplary embodiment of the present invention. FIG. 2 is a cross-sectional view of a display device, which is assembled, according to an exemplary embodiment of the present invention. FIG. 3 is a perspective view of a light source holder 520 included in a display device according to an exemplary embodiment of the present invention. FIG. 4 is a perspective view of a region of a lower receiving member 700 according to an exemplary embodiment of the present invention. FIG. 5 is a perspective view of a region of the lower receiving member 700 which is coupled to a plurality of light source units 500 according to an exemplary embodiment of the present invention. FIG. 6 is a cross-sectional view of a display device according to an exemplary embodiment of the present invention. FIG. 7 is a rear perspective view of a region of the lower receiving member 700 which is coupled to the light source units 500 according to an exemplary embodiment of the present invention. Referring to FIGS. 1 through 7, a display device according to an exemplary embodiment of the present invention includes a display assembly 10 and a backlight assembly 20. The display assembly 10 includes a liquid crystal display panel 100, a control board 200, a panel support member 300, and an upper receiving member 400.

The liquid crystal display panel 100 includes an upper substrate 110 having color filters and common electrodes, and a lower substrate 120 having thin-film transistors (TFTs) and pixel electrodes. A liquid crystal layer is interposed between the upper substrate 110 and the lower substrate 120.

A light-shielding pattern and red (R), green (G) and blue (B) filters are formed on the upper substrate 110. The R, G and B filters are color filters which express predetermined colors as light passes therethrough. Common electrodes, which comprise a transparent conductor such as indium tin oxide (ITO) or indium zinc oxide (IZO), are disposed on the light-shielding pattern and the color filters. In an exemplary embodiment, the light-shielding pattern and the color filters may be formed on the lower substrate 120.

The lower substrate 120 includes a plurality of pixel electrodes, which are arranged in a matrix, and a plurality of TFTs which are connected to the pixel electrodes. A source terminal of each TFT is connected to a data line, and a gate terminal of each TFT is connected to a gate line.

When a turn-on voltage is applied to a gate line, TFTs connected to the gate line are turned on. When an image signal is transmitted to each of the turned-on TFTs via a corresponding data line, each pixel electrode of a turned on TFTs is charged. Thus, an electric field is formed between the pixel electrodes of the lower substrate 120 and the common electrodes of the upper substrate 110. The electric field changes the arrangement of liquid crystals interposed between the upper substrate 110 and the lower substrate 120. As the arrangement of the liquid crystals changes, light transmittance is also changed. An image can be obtained using the change of light transmittance. In an exemplary embodiment, a polarizing sheet may be attached to a top surface of the upper substrate 110 and a bottom surface of the lower substrate 120.

The control board 200 transmits various signals used to display an image to the liquid crystal display panel 100. In FIG. 1, the control board 200 is electrically connected to the lower substrate 120 by a flexible printed circuit board 201 (FPCB). Various elements for driving the liquid crystal display panel 100 are mounted on the control board 200. The elements mounted on the control board 200 may include a voltage generator which generates an interval voltage, a grayscale voltage generator which generates a grayscale voltage, a data driver which provides an image signal to each data line, a gate driver which provides the turn-on voltage to each gate line, and a controller. The controller controls the operations of the voltage generator, the grayscale voltage generator, the data driver, and the gate driver. A signal converter, which converts an image signal received from an external system into a signal suitable for the liquid crystal display panel 100, may be mounted on the control board 200.

The above elements may be manufactured in the form of integrated circuit (IC) chips and may be electrically connected to electrodes disposed on the control board 200. A ground unit connected to ground terminals of the above elements can be mounted on the control board 200. In an exemplary embodiment, some elements such as, for example, the gate driver and the data driver may be mounted on the lower substrate 120. In an exemplary embodiment, the gate driver may be mounted directly on the lower substrate 120. In an exemplary embodiment, a ground of the lower substrate 120 is connected to the ground unit of the control board 200 by the FPCB 201.

The panel support member 300 supports the liquid crystal display panel 100. The panel support member 300 is shaped like a hollow square frame. Referring to FIG. 1, the panel support member 300 includes a hollow frame body 310 and a protruding portion 320 which protrudes from a lower region of each inner sidewall of the frame body 310 toward the empty space inside the frame body 310. The protruding portion 320 supports the liquid crystal display panel 100. That is, the liquid crystal display panel 100 is placed on the protruding portion 320.

A region of each inner sidewall of the frame body 310 where the protruding portion 320 is not formed (i.e., above the protruding portion 320) fixes each side surface of the liquid crystal display panel 100. That is, the inner sidewalls of the frame body 310 surround the side of the liquid crystal display panel 100 to prevent the liquid crystal display panel 100 from moving. The frame body 310 and the protruding portion 320 may be integrated with each other. The panel support member 300 may be manufactured by, for example, a pressing process or a molding process. The panel support member 300 may comprise resin such as, for example, plastic.

The upper receiving member 400 accommodates the liquid crystal display panel 100 and the panel support member 300 and is connected to the backlight assembly 20. The upper receiving member 400 may be coupled to the backlight assembly 20. The upper receiving member 400 includes a flat portion 410 which is shaped like a hollow square frame and sidewall portions 420 which extend from edge regions of the flat portion 410. The liquid crystal display panel 100, the panel support member 300 and the backlight assembly 20 are housed inside the flat portion 410 and the sidewall portions 420. Thus, the flat portion 410 and the sidewall portions 420 prevent the liquid crystal panel 100, the panel support member 300, and the backlight assembly 20 from moving out of the upper receiving member 400 and protect the above elements from external impact. The upper receiving member 400 may comprise a hard and light metal which is not easily deformed.

The backlight assembly 20 includes the light source units 500 which emit light, an optical member 600 which is disposed on the light source units 500, and the lower receiving member 700 which accommodates the light source units 500 and the optical member 600. Referring to FIG. 2, the backlight assembly 20 includes a reflective sheet 800 which reflects light from the light source units 500 and a light source power supply unit which supplies power to the light source units 500.

The lower receiving member 700 according to an exemplary embodiment of the present invention is shaped like a box having an open top end. The lower receiving member 700 protects elements housed therein from external impact. The lower receiving member 700 may comprise metal (e.g., aluminum (Al)), plastic, or a combination thereof. The lower receiving member 700 may be manufactured using various processing methods such as, for example, injection, extrusion, casting, forging, rolling, or cutting.

The lower receiving member 700 includes a bottom plate 710, sidewall portions 720 formed in edge regions of the bottom plate 710, and a plurality of through grooves 730 formed in each of two facing ones of the sidewall portions 720. Referring to FIG. 1, the bottom plate 710 is shaped like a square. Each of the two facing sidewall portions 720 includes an inner sidewall 721, an outer sidewall 723, and a connecting surface 722. The connecting surface 722 connects the inner sidewall 721 to the outer sidewall 723. The inner sidewall 721 extends upward from an edge region of the bottom plate 710. The connecting surface 722 extends from an upper end of the inner sidewall 721 in a direction away from the inner sidewall 721. The outer sidewall 723 extends downward from an end of the connecting surface 722.

Referring to FIG. 4, the inner sidewall 721 extends perpendicular to the bottom plate 710, and the outer sidewall 723 extends parallel to the inner sidewall 721. The connecting surface 722 extends parallel to the bottom plate 710. Referring to FIG. 2, the optical member 600 is placed on the connecting surface 722. Referring to FIGS. 1 through 4, the through grooves 730, into which the light source units 500 are inserted, are formed in each of the two facing ones of the sidewall portions 720.

The sidewall portions 720 are disposed respectively on four sides of the bottom plate 710 which is shaped like a square. Thus, the sidewall portions 720 may be divided into four regions. That is, when the bottom plate 710 is shaped like a square as shown, for example, in FIG. 1, the sidewall portions 720 may be divided into first and second sidewall regions 720a and 720b, which are disposed on two short sides of the square, and third and fourth sidewall regions 720c and 720d, which are disposed on two long sides of the square.

The through grooves 730 may be formed in any one of the four regions (i.e., the first through fourth sidewall regions 720a through 720d) of the sidewall portions 720. In an exemplary embodiment, a plurality of the through grooves 730 are formed in each of the first and second sidewall regions 720a and 720b. In an exemplary embodiment, an equal number of through grooves 730 may be formed in two of any sidewall regions that face each other. That is, an equal number of through grooves 730 may be formed in each of, for example, the third and fourth sidewall regions 720c and 720d. The number of through grooves 730 formed in one sidewall region may be equal to the number of light source units 500 formed in the lower receiving member 700 since the light source units 500 are inserted into the through grooves 730 of the sidewall region in an exemplary embodiment as shown, for example, in FIG. 5.

In an exemplary embodiment, the through grooves 730 are formed in each of the first and second sidewall regions 720a and 720b. In an exemplary embodiment, the through grooves 730 may penetrate the inner sidewall 721 and the outer sidewall 723 of each of the two facing ones of the sidewall portions 720, e.g., the first and second sidewall regions 720a and 720b. For example, referring to FIG. 4, each of the through grooves 730 includes a first groove portion 731 formed in the inner sidewall 721 and a second groove portion 732 formed in the outer sidewall 723. Each of the first and second groove portions 731 and 732 may substantially be shaped like a square. In an exemplary embodiment of the present invention, the shape of each of the first and second groove portions 731 and 732 may vary according to the cross-sectional shape of the light source holder 520 which is inserted into the first and second groove portions 731 and 732.

Each of the first and second sidewall regions 720a and 720b of the lower receiving member 700 includes a plurality of protrusions 724. The protrusions 724 may be formed on the connecting surface 722 of each of the first and second sidewall regions 720a and 720b. The protrusions 724 fix the panel support member 300 and the optical member 600. The protrusions 724 are inserted into slits 615 which are formed in fixing portions 616 of the optical member 600.

The protrusions 724 may be integrated with the lower receiving member 700. In an exemplary embodiment, side portions of the lower receiving member 700 may be cut and then bent upward to form the protrusions 724. For example, portions of the connecting surface 722 of the lower receiving member 700 can be cut and then bent upward to form the protrusions 724.

The through grooves 730, to which the light source units 500 are inserted, are formed in each of the first and second sidewall regions 720a and 720b of the lower receiving member 700. The optical member 600 is placed and fixed onto the connecting surface 722 of each of the first and second sidewall regions 720a and 720b. Therefore, according to an exemplary embodiment of the present invention, no mold frame is required to fix the light source units 500 and the optical member 600. The light source units 500 can be inserted and fixed to the through grooves 730 of the first sidewall region 720a.

In an exemplary embodiment, each of the light source units 500 includes a light source 510 and the light source holder 520. The light source holder 520 covers an end region (i.e., a tip end region) of the light source 510 and is inserted into each of the through grooves 730.

The light source 510 includes a light source body 511 and electrode portions 512 formed at both ends of the light source body 511. The space inside the light source body 511 is filled with a discharge gas, and a fluorescent substance is coated on an inner surface of the light source body 511. The electrode portions 512 include a positive electrode and a negative electrode. When a high voltage is applied to both ends of the light source 510, that is, the electrode portions 512, the electric discharge is generated, and the fluorescent substance is excited by the electric discharge. The excitation of the fluorescent substance causes the light source 510 to emit white light. The light source body 511 of the light source 510 emits light since the light source body 511 is positioned in a light-emitting region. However, since the electrode portions 512 at both ends of the light source 510 are positioned in non-light-emitting regions, the electrode portions 512 do not emit light.

Referring to FIGS. 1 and 2, the light source body 511 of the light source 510 may be shaped like a “U”, so that the positive and negative electrodes of the electrode portions 512 can be disposed adjacent to each other. The electrode portions 512 comprise metal having high electrical and thermal conductivity. In an exemplary embodiment, the light source 510 may be a cold cathode fluorescent lamp (CCFL). In an exemplary embodiment, the light source 510 may be an external electrode fluorescent lamp (EEFL).

Referring to FIG. 3, the light source holder 520 fixes and/or couples the light source 510 to the lower receiving member 700. The light source holder 520 includes a holder body 521, which covers both ends of the light source 510 (i.e., the electrode portions 512), and one or more fixing groove portions 522, which are formed in the holder body 521.

Referring to FIGS. 5 and 6, the light source holder 520 is inserted and fixed to each of the through grooves 730 formed in the first sidewall region 720a of the lower receiving member 700. That is, since the holder body 521, which covers the end region (i.e., tip end region) of each of the light source units 500, is inserted into each of the through grooves 730, the end region of each of the light source units 500 may be fixed to the lower receiving member 700. In an exemplary embodiment, each of the light source units 500 may be securely fixed to the first sidewall region 720a of the lower receiving member 700 by the fixing groove portions 522 of the holder body 521. That is, when the holder body 521 is inserted into each of the through grooves 730, a portion of the first sidewall region 720a around the corresponding through groove 730 is inserted into the fixing groove portions 522. Accordingly, the holder body 521 can be prevented from moving within the corresponding through groove 730 or moving out of the corresponding through groove 730.

Referring to FIG. 3, the fixing groove portions 522 include a first fixing groove portion 522a and a second fixing groove portion 522b. The first fixing groove portion 522a is formed in a front-end region of the holder body 521. The second fixing groove portion 522b is formed in a rear-end region of the holder body 521. The first fixing groove portion 522a is placed in the first groove portion 731 of each of the through grooves 730 and coupled to the inner sidewall 721 of the first sidewall region 720a. The second fixing groove portion 522b is placed in the second groove portion 732 of each of the through grooves 730 and coupled to the outer sidewall 723 of the first sidewall region 720a. In an exemplary embodiment, the holder body 521 is shaped like a hexahedron.

Referring to FIGS. 3, 5 and 6, the first fixing groove portion 522a is formed along four sides of the holder body 521, and the second fixing groove portion 522b is formed along at least three sides of the holder body 521. In an exemplary embodiment, the fixing groove portions 522 may be formed in at least one of the four sides of the holder body 521. For example, the fixing groove portions 522 may be formed along at least two sides of the holder body 521 to prevent the holder body 521 from moving within the corresponding through groove 730 or moving out of the corresponding through groove 730.

In an exemplary embodiment, the light source holder 520 of each of the light source units 500 may be inserted and fixed to each of the through grooves 730 formed in the first sidewall portion 720a of the lower receiving member 700. Therefore, no mold frame is required to fix the end region (i.e., tip end region) of each of the light source units 500. The light source units 500 are formed in the lower receiving member 700 by inserting the light source holder 520 of each of the light source units 500 into each of the through grooves 730.

Since no mold frame is used in an exemplary embodiment of the present invention, the attachment process of the reflective sheet 800 can be simplified. The reflective sheet 800 can be attached to each of the sidewall portions 720 of the lower receiving member 700 as shown, for example, in FIGS. 2 and 6. When a mold frame is used, it is difficult to attach a reflective sheet up to a side region of the mold frame because the mold frame is disposed after light source units are disposed. However, in an exemplary embodiment of the present invention, after the reflective sheet 800 is attached to an inner surface of the lower receiving member 700, (i.e., the bottom plate 710 and the inner sidewall 721 of each of the first and second sidewall regions 720a and 720b), a portion of the reflective sheet 800 in the region of each of the through grooves 730 of the inner sidewall 721 is cut. Thus, the reflective sheet 800 can be attached to the lower receiving member 700 before the light source units 500 are disposed in the lower receiving member 700. The reflective sheet 800 can be attached to the sidewall portions 720 of the lower receiving member 700.

Since the end region of each of the light source units 500 is inserted into the first sidewall region 720a of the lower receiving member 700, a dark area can be reduced. For example, the dark area can be reduced because a substantial portion of the light source holder 520, which may be seen as a dark portion, is placed in the space between the inner and outer sidewalls 721 and 723 of the first sidewall region 720a of the lower receiving member 700 as shown, for example, in FIGS. 5 and 6. Although a portion of the light source holder 520 protrudes beyond the inner sidewall 721 toward the center of the lower receiving member 700, the protruded length of the light source holder 520 is substantially negligible.

The light source holder 520 of each of the light source units 500 is inserted into one of the through grooves 730 of the first sidewall region 720a. Thus, the heat of the light source units 500 can be immediately released out of the lower receiving member 700. That is, since the light source holder 520 is inserted into the space between the inner and outer sidewalls 721 and 723 of the first sidewall region 720a, air can flow around and cool the light source holder 520. The first fixing groove portion 522a of the light source holder 520 is connected to the inner sidewall 721 of the sidewall region 720a, and the second fixing groove portion 522b of the light source holder 520 is connected to the outer sidewall 723 of the first sidewall region 720a. Therefore, the heat of the electrode portions 512 can be delivered to the inner sidewall 721 and the outer sidewall 723 of the first sidewall region 720a. Accordingly, the heat of the light source units 500 can be released immediately. As such, the light-emitting luminance deviation of the light source units 500 caused by temperature differences can be minimized.

Referring to FIG. 7, each of the light source units 500 includes voltage supply wires 530 which are connected to the electrode portions 512 and supply voltages to the electrode portions 512 to turn on a corresponding one of the light source units 500. Since the electrode portions 512 are covered by the light source holder 520, the voltage supply wires 530 penetrate the light source holder 520 to be connected to the electrode portions 512. Therefore, as shown, for example, in FIG. 7, wire fixing grooves 523, through which the voltage supply wires 530 pass, are formed in a portion of the light source holder 520 which is adjacent to the outer sidewall 723 of the first sidewall region 720a.

The wire fixing grooves 523 may be bent a plurality of times so that the voltage supply wires 530 are not disconnected from the electrode portions 512 by an external force and are taken out toward under the bottom plate 710 of the lower receiving member 700. In an exemplary embodiment of the present invention, the voltage supply wires 530 can be bent twice extending in a direction where the light source body 511 of each of the light source units 500 extends. That is, the wire fixing grooves 523 penetrate both of rear and bottom surfaces of the light source holder 520, and the cross-section of each of the wire fixing grooves 523, which is parallel to the rear surface of the light source holder 520, is shaped as follows: “ [symbol] ”. When the wire fixing grooves 523 penetrate both of the rear and bottom surfaces of the light source holder 520 and when the cross-section of each of the wire fixing grooves 523, which is parallel to the rear surface of the light source holder 520, is shaped as follows: “ [symbol] ”, first wire outlets 524 of the rear surface and second wire outlets 525 of the bottom surface are not aligned along a straight line. For this reason, the voltage supply wires 530 are inserted into the wire fixing grooves 523 as follows.

The voltage supply wires 530 connected to the electrode portions 512 are extended out through the first wire outlets 524 of the rear surface in a direction perpendicular to the rear surface of the light source body 511.

The voltage supply wires 530 extended out from the rear surface of the light source holder 520 are bent along the wire fixing grooves 523 in the “ [symbol] ” shape and then extended out through the second wire outlets 525 of the bottom surface of the light source holder 520.

Referring to FIG. 1, an equal number of through grooves 730 are formed in sidewall regions that face each other (e.g., the first and second sidewall regions 720a and 720b). Therefore, the light source units 500 can be coupled to the first and second sidewall regions 720a and 720b securely. That is, as shown, for example, in FIG. 2, the entire length (including lengths of the light source 510 and the light source holder 520) of each of the light source units 500 is greater than a long-axis length of the space inside the lower receiving member 700. Therefore, to insert the light source holder 520 of each of the light source units 500 into each of the through grooves 730 formed in a sidewall region (e.g., the first sidewall region 720a) of the lower receiving member 700, a portion of the light source 510 protrudes from another sidewall region (e.g., the second sidewall region 720b), which faces the above sidewall region (i.e., the first sidewall region 720a), by at least a length of the light source holder 520. The portion of the light source 510 protrudes from the sidewall region (e.g., the second sidewall region 720b) through each of the through grooves 730 formed in the sidewall region (e.g., the second sidewall region 720b).

In an exemplary embodiment, an equal number of through grooves 730 is formed in two facing sidewall regions. Therefore, a portion of the light source 510 can protrude from each of the through grooves 730 formed in the sidewall region that faces the sidewall region to which the light source holder 520 is coupled. Consequently, the light source units 500 can be coupled to the first and second sidewall regions 720a and 720b securely.

Referring to FIGS. 1 and 2, a light source support 740 may be formed on the bottom plate 710 of the lower receiving member 700 to support each of the light source units 500. A portion of the light source units 500 is fixed to one of the through grooves 730. The light source support 740 supports part of the light source body 511 and thus prevents the light source body 511 from being sunk downward due to dead load.

The optical member 600 is placed on the light source units 500 which are coupled and fixed to the through grooves 730 of the lower receiving member 700. The optical member 600 includes a luminance enhancing sheet 610 and at least one diffusion sheet 620. In an exemplary embodiment, plates may be used instead of the sheets 610 and 620. The luminance enhancing sheet 610 passes light that proceeds parallel to a transmission axis thereof and reflects light that proceeds in other directions. The diffusion sheet 620 diffuses light, so that light emitted from the light source units 500 is uniformly distributed over a wide range. In an exemplary embodiment, the optical member 600 may include various optical sheets or plates to change optical characteristics.

The optical member 600 includes the slits 615 at locations corresponding to the protrusions 724 of the lower receiving member 700. The slits 615 may respectively be formed in the fixing portions 616 which protrude from a side of the optical member 600. The protrusions 724 can be inserted into the slits 615 of the optical member 600, thereby fixing the optical member 600 to the lower receiving member 700.

In an exemplary embodiment, an edge region of the luminance enhancing sheet 610 and that of the diffusion sheet 620 may be adhered to the connecting surface 722 of each of the first and second sidewall regions 720a and 720b of the lower receiving member 700 by, for example, an adhesive member. The adhesive member may be, for example, an adhesive or a double-sided adhesive tape.

In an exemplary embodiment, a thermal diffusion plate or a thermal insulation plate may be formed in a lower portion of the optical member 600. The thermal diffusion plate or the thermal insulation plate may prevent the heat of the light source units 500 from being delivered to the liquid crystal display panel 100 and release the heat out of the lower receiving member 700.

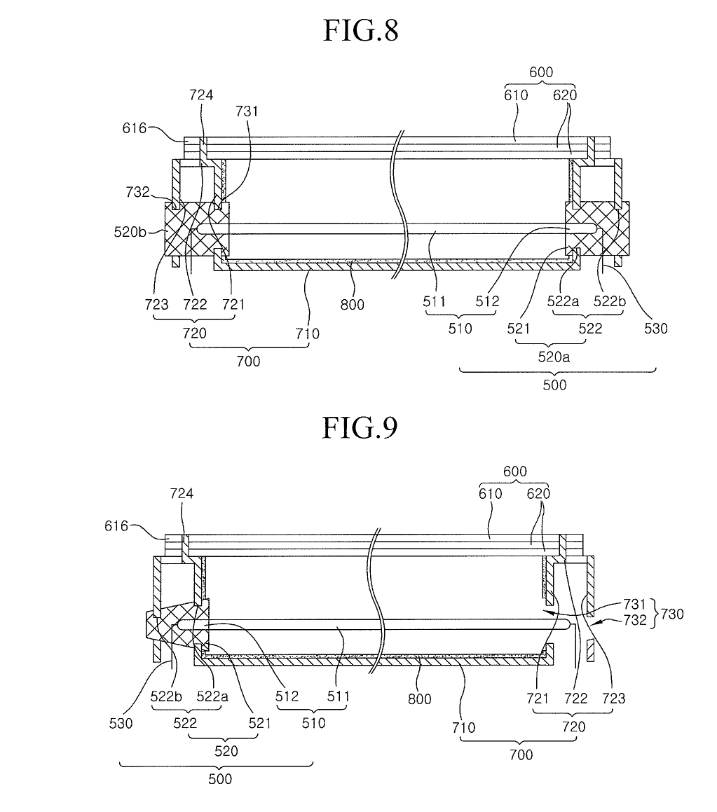

FIGS. 8 and 9 are cross-sectional views of a backlight assembly according to an exemplary embodiment of the present invention.

Referring to FIG. 8, a light source body 511 may be shaped like an “I”. Thus, light source holders 520a and 520b which respectively cover both ends of the light source body 511 may be formed. That is, the light source holders 520a and 520b may be manufactured as two separate elements. The light source holders 520a and 520b, which are separated from each other, may be coupled and fixed to through grooves 730 formed in two of sidewall portions 720 of a lower receiving member 700. That is, the light source holder 520a may be inserted to each of the through grooves 720 formed in a first sidewall region 720a, and the light source holder 520b may be inserted to each of the through grooves 730 formed in a second sidewall region 720b.

Referring to FIG. 9, first and second groove portions 731 and 732 of each of through grooves 730 may have different sizes. The cross section of a light holder 520 of each of light source units 500 may be trapezoidal. To couple the light source units 500 to the through grooves 730, an end of each of the light source units 500 passes through any one of the first and second groove portions 731 and 732 and then the other one of the first and second groove portions 731 and 732. That is, the end of each of the light source units 500 passes through the first groove portion 730 and then the second groove portion 732. Therefore, when the first groove portion 731 is larger than the second groove portion 732, the light source units 500 can be easily coupled to the through grooves 730. In an exemplary embodiment, the second groove portion 732 may be larger than the first groove portion 731.

In an exemplary embodiment, the lower receiving member 700 of the display device may include a plurality of receiving members which are manufactured separately, and the optical member 600 and the panel support member 300 may be fixed to the lower receiving member 700 by separate fixing protrusions.

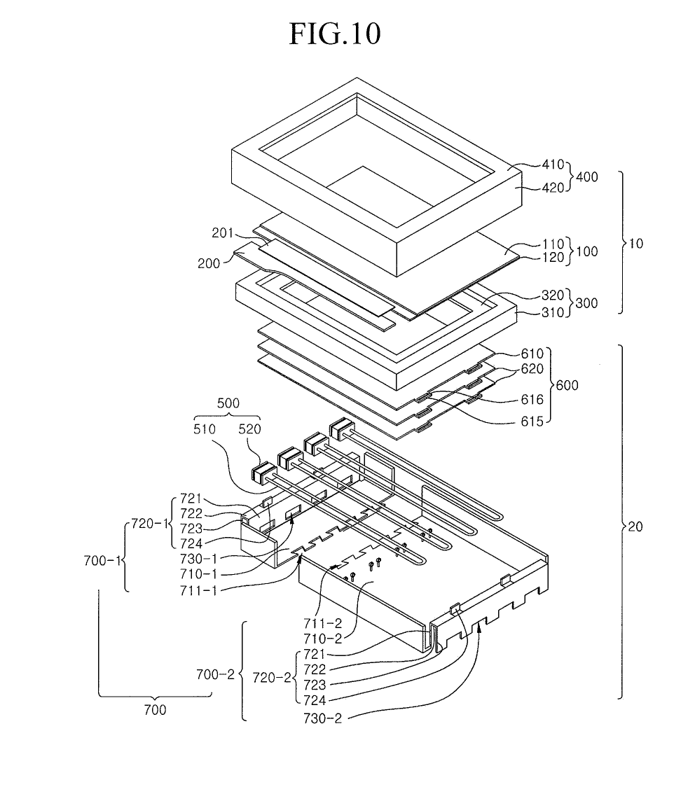

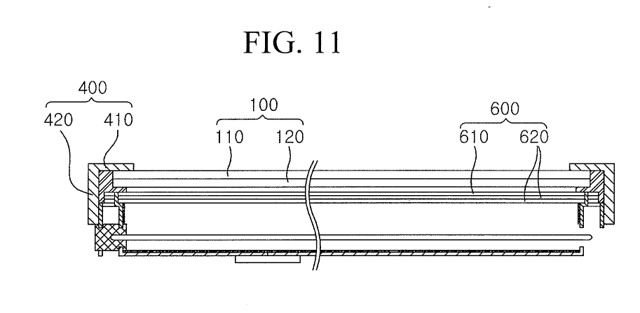

FIG. 10 is an exploded perspective view of a display device according to an exemplary embodiment of the present invention. FIG. 11 is a cross-sectional view of a display device, which is assembled, according to an exemplary embodiment of the present invention.

Referring to FIGS. 10 and 11, a backlight assembly of the display device includes a lower receiving member 700 which is divided into a first region and a second region. That is, the lower receiving member 700 includes a first receiving member 700-1 and a second receiving member 700-2. The first and second receiving members 700-1 and 700-2 are coupled to each other to form the lower receiving member 700 having space therein.

The first receiving member 700-1 includes a first bottom plate 710-1 and first sidewall portions 720-1 formed in three edge regions of the first bottom plate 710-1. The second receiving member 702-2 includes a second bottom plate 710-2 and second sidewall portions 720-2 formed in three edge regions of the second bottom plate 710-2. When the first and second bottom plates 710-1 and 710-2 are coupled to each other, the first and second bottom plates 710-1 and 710-2 may function as the bottom plate 710 of the lower receiving member 700. When the first and second sidewall portions 720-1 and 720-2 are coupled to each other, the first and second sidewall portions 720-1 and 720-2 may function as the sidewall portions 720 of the lower receiving member 700.

As shown in FIG. 10, the first bottom plate 710-1 is shaped like a square, and the first sidewall portions 720-1 are disposed on three sides of the first bottom plate 710-1. A side of the first bottom plate 710-1 on which the first sidewall portions 720-1 are not disposed is coupled to the second bottom plate 710-2. In an exemplary embodiment, the second bottom plate 710-2 is shaped like a square, and the second sidewall portions 720-2 are disposed on three sides of the second bottom plate 710-2. A side of the second bottom plate 710-2 on which the second sidewall portions 720-2 are not disposed is coupled to the first bottom plate 710-1.

Referring to FIG. 10, a first protruded and recessed pattern 711-1 is formed at the side of the first bottom plate 710-1 on which the first sidewall portions 720-1 are not disposed, and a second protruded and recessed pattern 711-2 corresponding to the first protruded and recessed pattern 711-1 is formed at the side of the second bottom plate 710-2 on which the second sidewall portions 720-2 are not disposed. Since the first and second protruded and recessed patterns 711-1 and 711-2 are coupled to each other when the first and second receiving members 700-1 and 700-2 are coupled to each other, the first and second receiving members 700-1 and 700-2 can be connected to each other. Referring to FIG. 11, a coupling member 712 (e.g., an adhesive tape) may be used to couple the first and second bottom plates 710-1 and 710-2 to each other.

In an exemplary embodiment of the present invention, a plurality of first through grooves 730-1 may be formed in one of the first sidewall portions 720-1 of the first receiving member 700-1, and a light source holder 520 of each of light source units 500 may be inserted into one of the first through grooves 730-1. Thus, the light source units 500 can be coupled to the first receiving member 701-1. That is, the light source units 500 are inserted into one of the first sidewall portions 720-1 of the small-sized first receiving member 700-1 instead of a receiving member shaped like a large-sized square box.

As shown in FIGS. 10 and 11, a plurality of second through grooves 730-2 corresponding to the first through grooves 730-1 may be formed in one of the second sidewall portions 720-2. Thus, the first receiving member 700-1 to which the light source units 500 are coupled can be connected to the second receiving member 700-2. That is, when the light source units 500 are coupled to the first receiving member 700-1, a sufficient processing margin for coupling the first and second receiving members 700-1 and 700-2 may not be secured because a length of the light source units 500 extends well beyond the first receiving member 700-1. However, when the second through grooves 730-2 are formed in the second receiving member 700-2 and a portion of each of the light source units 500 is inserted into one of the second through grooves 730-2, a sufficient processing margin can be secured.

Each of one of the first sidewall portions 720-1 and one of the second sidewall portions 720-2 according to an exemplary embodiment includes the inner sidewall 721, the connecting surface 722, and the outer sidewall 723. One of the first sidewall portions 720-1 and one of the second sidewall portions 720-2 respectively includes a plurality of protrusions 724 which protrude upward from the connecting surface 722 as shown, for example, in FIGS. 10 and 11. The protrusions 724 prevent an optical member 600, which is disposed above the connecting surface 722, from being disconnected from the lower receiving member 700 and fixes a panel support member 300. The protrusions 724 may be formed by cutting portions of the outer sidewall 723, which are adjacent to the connecting surface 722, and bending the cut portions upward (i.e., an opposite direction to the direction in which the outer sidewall 723 extends). In an exemplary embodiment, the protrusions 724 may be formed by cutting portions of the connecting surface 722. In an exemplary embodiment, the protrusions 724 may be formed by attaching separate protrusions to the connecting surface 722.

A plurality of grooves into which the protrusions 724 are inserted may be formed in a bottom surface of a frame body 310 of the panel support member 300. The grooves prevent the movement of the panel support member 300. In an exemplary embodiment, a plurality of slits 615 into which the protrusions 724 are inserted may be formed at a side of the optical member 600. That is, since the protrusions 724 are inserted into the slits 615 of the optical member 600, no adhesive is required to fix the optical member 600 to the connecting surface 722.

In an exemplary embodiment of the present invention, a plurality of through grooves are formed in a sidewall portion of a receiving member, and an end region (i.e., a dark region) of each light source unit is inserted into one of the through grooves. Thus, a mold frame is not required.

Since a light source holder which is disposed in the end region of each light source unit is inserted into one of the through grooves, the light source units can be arranged at regular intervals in the space inside the receiving member. Therefore, the process of manufacturing a backlight assembly can be simplified, and manufacturing time can be saved.

Since the light source holder which covers electrode portions (i.e., dark regions of the light source units) is inserted into the sidewall portion of the receiving member, the dark regions can be reduced. Since a portion of the light source holder, which is exposed to external air, is increased, the heat of the light source units can be released out of the receiving member.

Although exemplary embodiments of the present invention have been described herein with reference to the accompanying drawings, it is to be understood that the present invention should not be limited thereto and that various other changes and modifications may be affected therein by one of ordinary skill in the related art without departing from the scope or spirit of the invention. All such changes and modifications are intended to be included within the scope of the invention.

What is claimed is:

1. A backlight assembly comprising:
a receiving member comprising a bottom plate, a first sidewall portion substantially perpendicularly connected to a first end of the bottom plate, and a second sidewall portion substantially perpendicularly connected to a second end of the bottom plate, the first sidewall portion and the second sidewall portion facing each other,
wherein a plurality of through grooves are formed in the first sidewall portion and the second sidewall portion; and
a plurality of light source units, each light source unit comprising a light-emitting region and an end region, the light-emitting region disposed between the first end and the second end of the bottom plate, the end region penetrating each of the through grooves,
wherein each of the light source units is coupled to the receiving member.

2. The backlight assembly of claim 1, wherein a part of the end region of each light source unit protrudes beyond the bottom plate through each through groove.

3. The backlight assembly of claim 1, wherein each of the first and second sidewall portions comprises an inner sidewall extending upward from an end of the bottom plate, a connecting surface extending from an upper end of the inner sidewall, and an outer sidewall extending downward toward the bottom plate from an end of the connecting surface.

4. The backlight assembly of claim 3, wherein each of the through grooves comprises a first groove portion formed in the inner sidewall and a second groove portion formed in the outer sidewall.

5. The backlight assembly of claim 4, wherein the first and second groove portions have different sizes.

6. The backlight assembly of claim 4, wherein each of the first and second sidewall portions further comprises a plurality of protrusions protruding upward from the connecting surface.

7. The backlight assembly of claim 6, further comprising an optical member placed on the receiving member, the optical member having a plurality of slits for receiving the protrusions therein.

8. The backlight assembly of claim 6, wherein the protrusions are formed by cutting portions of the connecting surface and bending the cut portions upward.

9. The backlight assembly of claim 4, wherein the receiving member further includes a third sidewall portion and a fourth sidewall portion facing each other formed on the bottom plate, and the through grooves are formed in at least one of the first through fourth sidewall portions.

10. The backlight assembly of claim 9, wherein the first sidewall portion and the second sidewall portion have the same number of the through grooves.

11. The backlight assembly of claim 1, wherein each of the light source units further comprises a light source body emitting light, electrode portions formed at both ends of the light source body, and a light source holder receiving the electrode portions therein, wherein the light source holder is inserted into each of the through grooves.

12. The backlight assembly of claim 11, wherein the light source holder penetrates each of the through grooves such that an end of the light source holder is exposed outside the receiving member.

13. The backlight assembly of claim 11, wherein a substantial portion of the light source holder is placed between the inner sidewall and the outer sidewall.

14. The backlight assembly of claim 12, wherein the light source holder further comprises fixing groove portions receiving a part of one of the first and second sidewall portions.

15. The backlight assembly of claim 11, wherein each of the light source units further comprises voltage supply wires penetrating the light source holder and are connected to the electrode portions.

16. The backlight assembly of claim 15, wherein the light source holder further comprises wire fixing grooves for extending the voltage supply wires out of the light source holder.

17. The backlight assembly of claim 16, wherein the wire fixing grooves penetrate both of rear and bottom surfaces of the light source holder, and the voltage supply wires extend out of the light source holder through the rear surface of the light source holder and bent toward the bottom surface of the light source holder.

18. The backlight assembly of claim 17, wherein the wire fixing grooves comprise first wire outlets formed in the rear surface of the light source holder and second wire outlets formed in the bottom surface of the light source holder, wherein the first wire outlets and the second wire outlets are not aligned along a straight line.

19. The backlight assembly of claim 11, wherein a cross-section of each of the wire fixing grooves is shaped like “ [symbol] ”.

20. The backlight assembly of claim 1, wherein the bottom plate includes a first portion and a second portion coupled to the first portion.

21. The backlight assembly of claim 20, wherein each of the third wall portion and the fourth wall portions is divided into two regions.

22. The backlight assembly of claim 21, wherein the first portion and the second portion of the bottom plate are combined using protruded and recessed patterns.

23. The backlight assembly of claim 21, wherein the through grooves are formed in at least one of the first and second sidewall portions.

24. The backlight assembly of claim 1, further comprising a reflective sheet attached to the bottom plate and a surface of each of the first and second sidewall portions.

25. A display device comprising:
a backlight assembly comprising a receiving member, the receiving member comprising:
a bottom plate and sidewall portions forming a space, wherein a plurality of through grooves are formed in each of two sidewall portions facing each other; and
a plurality of light source units, each light source unit comprising a light-emitting region disposed in the space and an end region penetrating each of the through grooves; and
a display panel disposed on the receiving member,
wherein each of the light source units is coupled to the receiving member.

26. The display device of claim 25, wherein a part of the end region protrudes from the space in a direction away from a center of the space.

27. The display device of claim 26, further comprising:
a panel support member interposed between the receiving member and the display panel, the panel support member fixing and supporting the display panel; and
an optical member interposed between the panel support member and the light source units.

28. The display device of claim 27, wherein each of the two facing sidewall portions comprises an inner sidewall extending upward from an edge region of the bottom plate, a connecting surface extending from an upper end of the inner sidewall in the direction away from the center of the space, and an outer sidewall extending downward toward the bottom plate from an end of the connecting surface.

29. The display device of claim 28, wherein each of the through grooves comprises a first groove portion formed in the inner sidewall and a second groove portion formed in the outer sidewall.

30. The display device of claim 29, wherein each of the two facing sidewall portions further comprises a plurality of protrusions protruding upward from the connecting surface.

31. The display device of claim 30, wherein the optical member further comprises a plurality of slits for receiving the protrusions, and the panel support member further comprises grooves for receiving the protrusions.
